(19) United States
(12) Patent Application Publication
(10) Pub. No.: US 2025/0251014 A1
(43) Pub. Date: Aug. 7, 2025

(54) PRESSURE RELIEF DEVICE FOR SUCTION CUP

(71) Applicant: Xiamen Chixue Sports Goods Co., Ltd., Xiamen (CN)

(72) Inventors: Zi Yan PU, Xiamen (CN); Jian jun XU, Xiamen (CN); Guang yan LIU, Xiamen (CN)

(21) Appl. No.: 19/037,290

(22) Filed: Jan. 27, 2025

(30) Foreign Application Priority Data
Feb. 4, 2024 (CN) 202420268961X

(51) Int. Cl. F16B 47/00; A63C 11/06; A63C 11/08; B25B 11/00

(52) U.S. Cl. CPC F16B 47/006; A63C 11/06; A63C 11/08; B25B 11/007

(57) ABSTRACT

A pressure relief device for a suction cup, is provided, including the suction cup, a rod body, and a pressure relief assembly; the suction cup is arranged at one end of the rod body, the rod body is also provided with a first air relief groove and a first air hole in the first air relief groove, and the first air hole runs through the rod body so that an air pipeline is in communication with the outside; the pressure relief assembly includes a first pressure relief member and a first blocking end, the first blocking end is placed in the air pipeline from the first air relief groove, the first blocking end is in transmission connection with the first pressure relief member, the first blocking end can block the first air hole or be separated from the first air hole under the drive of the first pressure relief member.

### CROSS REFERENCE TO THE RELATED APPLICATIONS

This application is based upon and claims priority to Chinese Patent Application No. 202420268961X, filed on Feb. 4, 2024, the entire contents of which are incorporated herein by reference.

### TECHNICAL FIELD

The present invention relates to the field of suction cups, and specifically to a pressure relief device for a suction cup.

### BACKGROUND

Suction cups are a kind of items attached to an object by virtue of a difference in internal and external atmospheric pressures, which may be a pendant or a tool for grabbing an object. Suction cups are mostly made of nitrile rubber, which has high tensile strength and is therefore widely used in various vacuum holding devices.

For example, in an edge sharpening device for skis, the ski is held by a suction cup and then subjected to edge sharpening and waxing operations. When the operations are completed, the suction cup needs to be released from vacuum by external force, which is inconvenient to operate.

### SUMMARY

In view of the above problems, the present invention provides a pressure relief device for a suction cup, which solves the problem of inconvenient operation when breaking vacuum of a suction cup.

To achieve the above objective, the present application provides a pressure relief device for a suction cup, including the suction cup, a rod body, and a pressure relief assembly; the rod body includes an air pipeline, a first end, and a first air relief groove, the air pipeline runs through the rod body, the suction cup is arranged at the first end, the rod body is also provided with a first air hole in the first air relief groove, the first air hole runs through the rod body so that the air pipeline is in communication with the outside; the pressure relief assembly includes a first pressure relief member and a first blocking end, the first blocking end is placed in the air pipeline from the first air relief groove, the first blocking end is in transmission connection with the first pressure relief member, the first blocking end can block the first air hole under the drive of the first pressure relief member to close the air pipeline, or, the first blocking end can be separated from the first air hole under the drive of the first pressure relief member to make the air pipeline in communication with the outside.

In some embodiments, the first air relief groove is further provided with a first accommodating chamber, the first accommodating chamber is provided with a first opening facing the outside, the first air hole penetrates the first accommodating chamber, air enters the first accommodating chamber from the first air hole and then enters the air pipeline through the first accommodating chamber; the first blocking end is placed in the first accommodating chamber from the first opening.

In some embodiments, the first pressure relief member includes a first protruding portion and a first gripping portion, the first protruding portion is placed in the first accommodating chamber and can move relative to the first accommodating chamber; the first gripping portion extends out of the first accommodating chamber and is placed outside the rod body, a force can be applied to the first gripping portion to drive the first protruding portion to move relative to the first accommodating chamber.

In some embodiments, the first blocking end is an outer surface of the first protruding portion; the pressure relief assembly also includes a sealing ring, the sealing ring is arranged at a joint between the first accommodating chamber and the air pipeline, and the first blocking end is driven by the first pressure relief member to compress the sealing ring so that the first blocking end blocks the air pipeline.

In some embodiments, the first blocking end is arranged on the first protruding portion, and the pressure relief assembly further includes a first venting pipeline, the first venting pipeline and the first blocking end are arranged on the first protruding portion in a cross manner; the first gripping portion is used to drive the first protruding portion to rotate by a first preset angle, so that two ends of the first venting pipeline are respectively in communication with the first air hole and the air pipeline; the first gripping portion is also used to drive the first protruding portion to rotate by a second preset angle, so that the first blocking end respectively abuts against the first air hole and the air pipeline.

In some embodiments, the first venting pipeline has a first connecting portion and a second connecting portion, and the first connecting portion and the second connecting portion are arranged at an angle; when the first protruding portion rotates by the first preset angle, the first connecting portion is in communication with the first air hole, and the second connecting portion is in communication with the air pipeline.

In some embodiments, the pressure relief assembly also includes a rotating plate and an elastic member, the rotating plate includes the first blocking end and a first transmission end, the rotating plate and the rod body are hinged in the first accommodating chamber, and the first transmission end is in transmission connection with the first protruding portion; the elastic member is arranged between the first accommodating chamber and the first protruding portion, and the first protruding portion can move toward the outside of the rod body under the drive of the elastic member.

In some embodiments, the first protruding portion is provided with a connecting groove, and the first transmission end is embedded in the connecting groove; or, the first protruding portion is provided with a first convex column, the first transmission end is provided with a first through hole, and the first convex column passes through the first through hole, so that the first protruding portion is connected to the first transmission end.

In some embodiments, the first blocking end is coated with a rubber layer, a plastic layer, or a silicone layer.

In some embodiments, the pressure relief assembly also includes a cover plate, and the cover plate is arranged at the first opening to close the first opening.

Different from the prior art, in the above technical solution, the pressure relief device for the suction cup includes the suction cup, the rod body, and the pressure relief assembly; the suction cup is arranged at one end of the rod body, the rod body is provided with the first air relief groove, the rod body is further provided with the first air hole in the first air relief groove, and the first air hole runs through the rod body so that the air pipeline is in communication with the outside; the pressure relief assembly includes the first pressure relief member and the first blocking end, the first blocking end is placed in the air pipeline from the first air relief groove, the first blocking end is in transmission connection with the first pressure relief member, and the first blocking end can block the first air hole under the drive of the first pressure relief member to close the air pipeline, so that the suction cup remains in a vacuum suction state, or, the first blocking end can also be separated from the first air hole under the drive of the first pressure relief member, so that the air pipeline is in communication with an external environment, thereby releasing the suction cup from the vacuum state. When in use, a user only needs to apply force in the corresponding direction at the first pressure relief member. For a ski edge sharpening device, multiple suction cups can be easily operated after the completion of edge sharpening and waxing to improve the operating efficiency.

The above-mentioned contents of the invention are only a summary of the technical solutions of the present invention. To enable those skilled in the art to more clearly understand the technical solutions of the present invention and then to implement them according to the contents of the specification and the drawings, and to facilitate the understanding of the above-mentioned objectives and other purposes, features, and advantages of the present invention, the following is a description in combination with the specific implementations and drawings of the present invention.

### BRIEF DESCRIPTION OF THE DRAWINGS

The accompanying drawings are only used to illustrate the principles, implementation modes, applications, characteristics, and effects of the specific embodiments of the present invention and other related contents, and cannot be considered as limitations of the present invention.

In the drawings of the specification:

FIG. 1 is a first schematic diagram of the pressure relief device for a suction cup described in the specific embodiment;

FIG. 2 is a partial cross-sectional view of FIG. 1;

FIG. 3 is a second schematic diagram of the pressure relief device for a suction cup described in the specific embodiment;

FIG. 4 is a schematic diagram of the first pressure relief member in FIG. 3;

FIG. 5 is a partial cross-sectional view of FIG. 3;

FIG. 6 is a third schematic diagram of the pressure relief device for a suction cup described in the specific embodiment;

FIG. 7 is a partial cross-sectional view of FIG. 6.

The reference numerals in the above figures are described as follows:
1. pressure relief assembly;
11. first pressure relief member;
111. first protruding portion;
112. first gripping portion;
12. first blocking end;
13. sealing ring;
14. first venting pipeline;
15. rotating plate;
151. first transmission end;
16. elastic member;
17. cover plate;
2. rod body;
21. first air relief groove;
22. air pipeline;
23. first air hole;
24. first accommodating chamber;
3. suction cup.

### DETAILED DESCRIPTION OF THE EMBODIMENTS

In order to explain in detail the possible application scenarios, technical principles, specific schemes that can be implemented, and the purposes and effects that can be achieved of the present invention, the following is a detailed description in combination with the specific embodiments listed and the accompanying drawings. The embodiments described herein are only used to more clearly illustrate the technical solutions of the present invention, and are therefore only used as examples, but cannot be used to limit the scope of protection of the present invention.

In the present invention, “embodiment” mentioned means that the specific features, structures, or characteristics described in conjunction with the embodiment may be included in at least one embodiment of the present invention. The word “embodiment” appearing in various parts of the specification does not necessarily refer to the same embodiment, nor does it particularly limit its independence or association with other embodiments. In principle, in the present invention, as long as there is no technical contradiction or conflict, the various technical features mentioned in each embodiment can be combined in any way to form a corresponding implementable technical solution.

Unless otherwise defined, the technical terms used herein have the same meanings as those generally understood by those skilled in the art to which the present invention belongs; the use of relevant terms herein is only for describing specific embodiments and is not intended to limit the present invention.

In the description of the present invention, the term “and/or” is an expression used to describe the logical relationship between objects, indicating that three relationships may exist, for example, A and/or B means: A exists, B exists, and A and B exist at the same time. In addition, the character “/” in the present invention generally indicates that the objects before and after are in a logical relationship of “or”.

In the present invention, the terms such as “first”, “second”, and the like are merely used to distinguish one entity or operation from another entity or operation, and do not necessarily require or imply any actual relationship of quantity, priority, or sequence among these entities or operations.

Without further restrictions, in the present invention, the words “include(s)”, “comprise(s)”, “have/has”, or other similar open-ended expressions used in sentences are intended to cover non-exclusive inclusion. These expressions do not exclude the presence of additional elements in the process, method, or product including the elements, so that the process, method, or product including a series of elements may include not only those limited elements, but also other elements not explicitly listed, or also include elements inherent to such process, method, or product.

Similar to the understanding in the Examination Guidelines, in the present invention, the expressions such as “greater than”, “less than”, “exceed”, and the like are understood to exclude the number itself; the expressions such as “above”, “below”, “within”, and the like are understood to include the number itself. In addition, in the description of the embodiments of the present invention, the meaning of “a/the plurality of/multiple” is more than two (including two), and similar expressions related to “a/the plurality of/multiple” are also understood in this way, such as “a/the plurality of/multiple groups”, “a/the plurality of/multiple times”, etc., unless otherwise clearly and specifically limited.

In the description of the embodiments of the present invention, the space-related expressions used, such as “center”, “longitudinal”, “lateral”, “length”, “width”, “thickness”, “up”, “down”, “front”, “back”, “left”, “right”, “vertical”, “horizontal”, “vertical”, “top”, “bottom”, “inside”, “outside”, “clockwise”, “counterclockwise”, “axial”, “radial”, “circumferential”, etc., indicate the orientation or position relationship based on the orientation or position relationship shown in the specific embodiments or drawings, and are only for the convenience of describing the specific embodiments of the present invention or facilitating the reader's understanding, but do not indicate or imply that the referred device or component must have a specific position, a specific orientation, or be constructed or operated in a specific orientation, and therefore cannot be understood as a limitation on the embodiments of the present invention.

Unless otherwise expressly specified or limited, in the description of the embodiments of the present invention, the terms such as “install/mount”, “link”, “connect”, “fix”, “set/provide/arrange”, and the like used should be understood in a broad sense. For example, the “connection” can be a fixed connection, a detachable connection, or an integrated setting; it can be a mechanical connection, an electrical connection, or a communication connection; it can be a direct connection, or an indirect connection through an intermediate medium; it can be an internal communication between two elements or an interaction relationship between two elements. For those skilled in the art to which the present invention belongs, the specific meanings of the above terms in the embodiments of the present invention can be understood according to the specific circumstances.

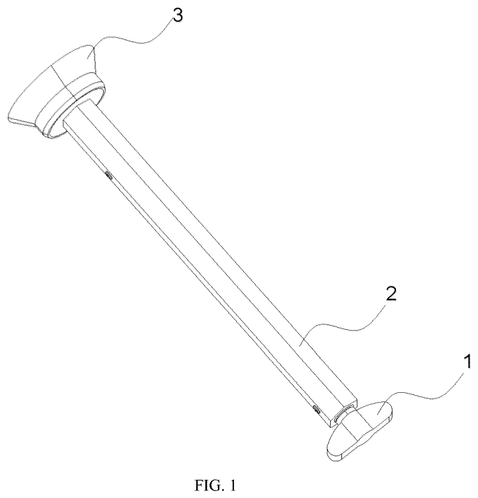

Referring to FIG. 1 to FIG. 7, the present embodiment provides a pressure relief device for a suction cup 3, including the suction cup 3, a rod body 2, and a pressure relief assembly 1; the rod body 2 includes an air pipeline 22, a first end, and a first air relief groove 21, the air pipeline 22 runs through the rod body 2, the suction cup 3 is arranged at the first end, the rod body 2 is also provided with a first air hole 23 in the first air relief groove 21, the first air hole 23 runs through the rod body 2 so that the air pipeline 22 is in communication with the outside; the pressure relief assembly 1 includes a first pressure relief member 11 and a first blocking end 12, the first blocking end 12 is placed in the air pipeline 22 from the first air relief groove 21, the first blocking end 12 is in transmission connection with the first pressure relief member 11, the first blocking end 12 can block the first air hole 23 under the drive of the first pressure relief member 11 to close the air pipeline 22, or, the first blocking end 12 can be separated from the first air hole 23 under the drive of the first pressure relief member 11 to make the air pipeline 22 in communication with the outside.

In the present embodiment, the rod body 2 and the suction cup 3 can form a suction cup 3 with screw. It should be noted that the present embodiment does not limit the shape of the rod body 2. The cross section of the rod body 2 can be rectangular, square, irregular, polygonal, circular, elliptical, or any arc-shaped. The material of the rod body 2 can be metal or non-metal, etc., and the suction cup 3 can be any general suction cup 3 available on the market.

It should be noted that the rod body 2 is provided with the first air relief groove 21, and the first blocking end 12 is provided in the first air relief groove 21. The first air relief groove 21 can be arranged on a side of the rod body 2 or an end of the rod body 2. For the convenience of illustration, the figure shows, as an example, the first air relief groove 21 arranged at an end of the rod body 2, which, however, does not constitute a limitation of the present application.

Specifically, the rod body 2 includes the air pipeline 22, the first end, and the first air relief groove 21. The air pipeline 22 can be understood as an air pipeline 22 used when the suction cup 3 is vacuumed. The air pipeline 22 is in communication with the suction cup 3, and the first end is an end of the rod body 2 where the suction cup 3 is provided. The first air hole 23 is provided on the first air relief groove 21, and the first air hole 23 is in communication with the air pipeline 22. As a result, by opening and closing the first air hole 23, the adjustment of value of air pressure in the air pipeline 22 can be controlled, including converting it from a vacuum state to a vacuum-broken state.

In the present embodiment, the pressure relief assembly 1 includes the first pressure relief member 11 and the first blocking end 12. The first blocking end 12 is placed in the first air relief groove 21. The first blocking end 12 can block the first air hole 23. The first pressure relief member 11 is in transmission connection with the first blocking end 12. The first blocking end 12 is driven by the first pressure relief member 11 to move so that the first blocking end 12 blocks the first air hole 23 or detaches from the first air hole 23.

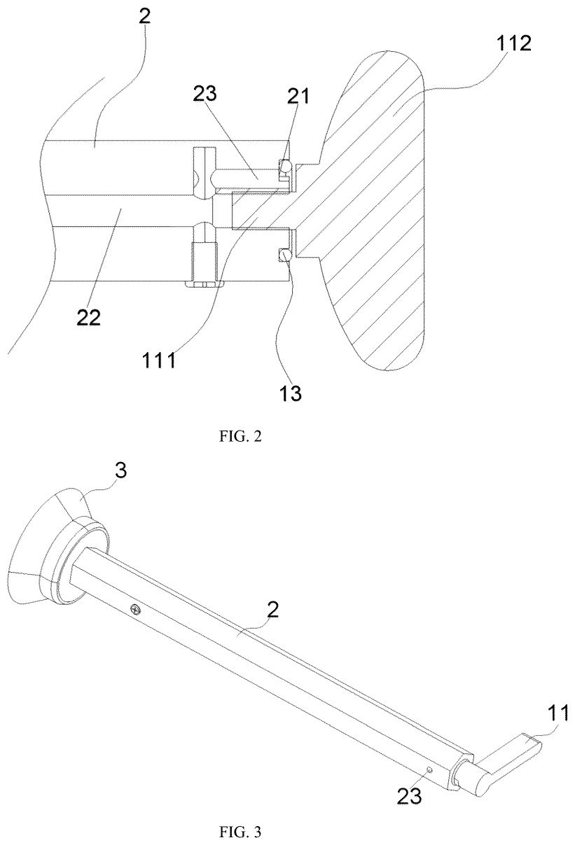

Specifically, referring to FIG. 2 to FIG. 7, in some embodiments, the first air relief groove 21 is further provided with a first accommodating chamber 24, and the first accommodating chamber 24 is provided with a first opening facing the outside. The first air hole 23 penetrates the first accommodating chamber 24, and air enters the first accommodating chamber 24 from the first air hole 23 and then enters the air pipeline 22 through the first accommodating chamber 24; the first blocking end 12 is placed in the first accommodating chamber 24 from the first opening.

In the present embodiment, the first air hole 23 penetrates the first accommodating chamber 24, which can be understood as the first air hole 23 running through the rod body 2 and being placed in an area covered by the first accommodating chamber 24, and the air can enter the first accommodating chamber 24 from the first air hole 23 and then enter the air pipeline 22 through the first accommodating chamber 24.

Referring to FIG. 1 to FIG. 7, in some embodiments, the first pressure relief member 11 includes a first protruding portion 111 and a first gripping portion 112. The first protruding portion 111 is placed in the first accommodating chamber 24 and can move relative to the first accommodating chamber 24; the first gripping portion 112 extends out of the first accommodating chamber 24 and is placed outside the rod body 2, and a force can be applied to the first gripping portion 112 to drive the first protruding portion 111 to move relative to the first accommodating chamber 24.

In the present embodiment, the first protruding portion 111 and the first gripping portion 112 can be understood as two parts of the first pressure relief member 11, where the first protruding portion 111 can be placed in the first accommodating chamber 24, and the first gripping portion 112 is placed outside the rod body 2, so that a user can grab the first gripping portion 112 to apply a force to the first gripping portion 112 to drive the first protruding portion 111 to move relative to the first accommodating chamber 24, and the first blocking end 12 is in transmission connection with the first protruding portion 111.

Referring to FIG. 1 and FIG. 2, in some embodiments, the first blocking end 12 is an outer surface of the first protruding portion 111; the pressure relief assembly 1 also includes a sealing ring 13, the sealing ring 13 is arranged at a joint between the first accommodating chamber 24 and the air pipeline 22, and the first blocking end 12 is driven by the first pressure relief member 11 to compress the sealing ring 13 so that the first blocking end 12 blocks the air pipeline 22.

In the present embodiment, the first blocking end 12 is an outer surface of the first protruding portion 111, which specifically includes all outer surfaces of the first protruding portion 111, as shown in FIG. 2, when the first protruding portion 111 is cylindrical, the first blocking end 12 includes the outer side wall and the end surface of the first protruding portion 111, in FIG. 2, the first blocking end 12 is the end surface of the first protruding portion 111.

The sealing ring 13 is further provided in the first pressure relief groove. The sealing ring 13 can be understood as including various types, specifically an O-ring, a rubber ring, etc. When the first pressure relief member 11 is pressed toward the rod body 2, the sealing ring 13 can block the connection gap between the first pressure relief member 11 and the first pressure relief groove, so that the first blocking end 12 blocks the first air hole 23, making the air pipeline 22 in a vacuum state. When the suction cup 3 needs to be released from vacuum, the first pressure relief member 11 can be pulled out, so that the first blocking end 12 is separated from the first air hole 23, allowing air to enter the air pipeline 22 from the first air hole 23.

In some optional embodiments, the first pressure relief groove is arranged on a side of the rod body 2, and the first pressure relief member 11 is correspondingly arranged on a side of the rod body 2.

Referring to FIG. 3 to FIG. 5, in some embodiments, the first blocking end 12 is arranged on the first protruding portion 111, and the pressure relief assembly 1 further includes a first venting pipeline 14, the first venting pipeline 14 and the first blocking end 12 are arranged on the first protruding portion 111 in a cross manner; the first gripping portion 112 is used to drive the first protruding portion 111 to rotate by a first preset angle, so that two ends of the first venting pipeline 14 are respectively in communication with the first air hole 23 and the air pipeline 22; the first gripping portion 112 is also used to drive the first protruding portion 111 to rotate by a second preset angle, so that the first blocking end 12 respectively abuts against the first air hole 23 and the air pipeline 22.

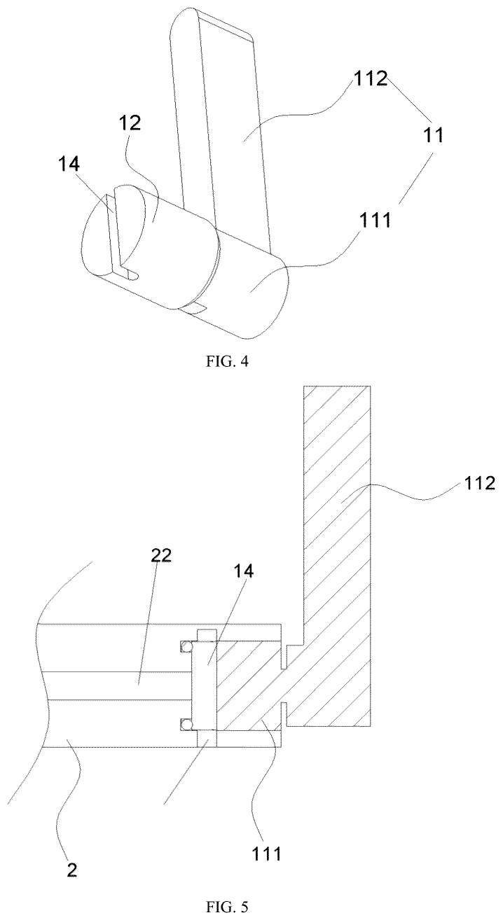

The present embodiment shows another implementation of the first pressure relief member 11, the first blocking end 12 is arranged on the first protruding portion 111, the first venting pipe 14 is also arranged on the first protruding portion 111, the first blocking end 12 and the first venting pipe 14 are arranged in a cross manner, referring to FIG. 4 and FIG. 5 for details, the first blocking end 12 is the outer surface of the first protruding portion 111, and the first venting pipe 14 is a long groove, when the first protruding portion 111 is rotated, the first venting pipe 14 can be rotated to the first air hole 23, so that the first air hole 23 is in communication with the air pipeline 22, and the first venting pipe 14 can also be rotated away from the first air hole 23, so that the first blocking end 12 abuts against the first air hole 23 to block the first air hole 23.

In some embodiments, the first venting pipeline 14 has a first connecting portion and a second connecting portion, and the first connecting portion and the second connecting portion are arranged at an angle; when the first protruding portion 111 rotates by the first preset angle, the first connecting portion is in communication with the first air hole 23, and the second connecting portion is in communication with the air pipeline 22. In the present embodiment, the first venting pipeline 14 can be configured as an L-type or a V-type, and the first connecting portion and the second connecting portion correspondingly serve as two parts of the L-type or the V-type. In the present embodiment, the first preset angle and the second preset angle can be set according to actual needs.

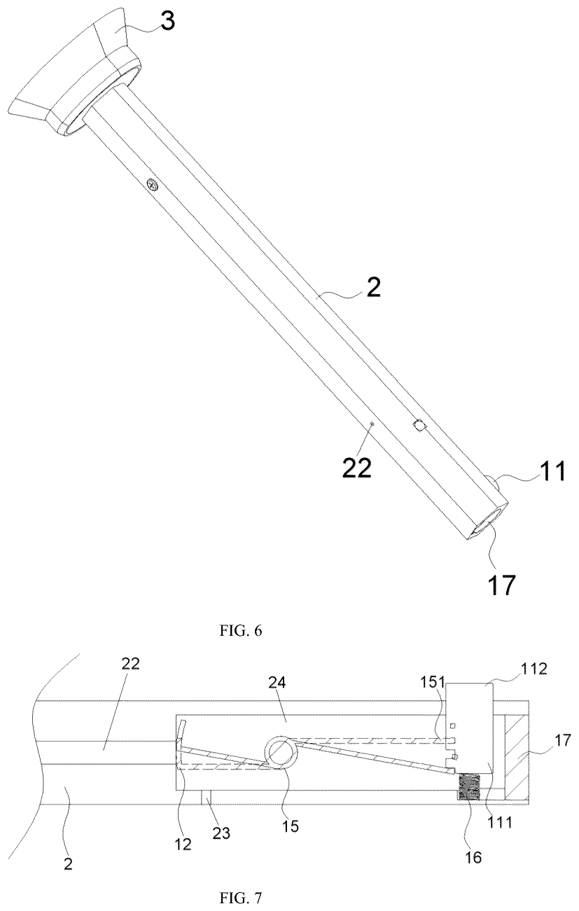

Referring to FIG. 6 and FIG. 7, in some embodiments, the pressure relief assembly 1 also includes a rotating plate 15 and an elastic member 16. The rotating plate 15 includes the first blocking end 12 and a first transmission end 151. The rotating plate 15 and the rod body 2 are hinged in the first accommodating chamber 24, and the first transmission end 151 is in transmission connection with the first protruding portion 111; the elastic member 16 is arranged between the first accommodating chamber 24 and the first protruding portion 111, and the first protruding portion 111 can move toward the outside of the rod body 2 under the drive of the elastic member 16.

In the present embodiment, the rotating plate 15 can be in the shape shown in FIG. 7, the first blocking end 12 and the first transmission end 151 are respectively understood as two ends of the rotating plate 15, the rotating plate 15 is hinged to the rod body 2, the rotating plate 15 is placed in the first accommodating chamber 24, the first transmission end 151 is in transmission connection with the first protruding portion 111, the elastic member 16 can be a spring, the spring is arranged between the first accommodating chamber 24 and the first protruding portion 111, and the elastic member 16 can provide a restoring force to the first protruding portion 111.

It should be noted that the first air hole 23 here includes a first part and a second part, the first part is arranged on the rod body 2 and passes through the side wall of the first accommodating chamber 24, and the second part is arranged between the first accommodating chamber 24 and the air pipeline 22, so that the first accommodating chamber 24 is in communication with the air pipeline 22. The first blocking end 12 blocks the second part, and the first part remains in a normally open state, that is, the first part is always in communication with the outside.

When the first gripping portion 112 is pressed, the first protruding portion 111 is driven by the first gripping portion 112 to rotate the rotating plate 15, so that the first blocking end 12 detaches from the second part, and the first accommodating chamber 24 is in communication with the air pipeline 22, thereby achieving pressure relief of the suction cup 3. When the first gripping portion 112 is released, the first protruding portion 111 resets under the drive of the elastic member 16, so that the first protruding portion 111 re-blocks the second part, thereby isolating the air pipeline 22 from an external environment.

In some embodiments, the first protruding portion 111 is provided with a connecting groove, and the first transmission end 151 is embedded in the connecting groove; or, the first protruding portion 111 is provided with a first convex column, the first transmission end 151 is provided with a first through hole, and the first convex column passes through the first through hole, so that the first protruding portion 111 is connected to the first transmission end 151. The present embodiment shows two forms of connection between the first transmission end 151 and the first protruding portion 111. It should be noted that the rotating plate 15 and the first protruding portion 111 can be made of materials with a certain deformation, such as metal, plastic, or the like. When the first pressure relief member 11 is pressed, a slight deformation occurs at the joint between the first protruding portion 111 and the first transmission end 151 to achieve a transmission connection between the two.

In some embodiments, the first blocking end 12 is coated with a rubber layer, a plastic layer, or a silicone layer, which can increase the air tightness between the first blocking end 12 and the first air hole 23 when connected.

Referring to FIG. 6 and FIG. 7, in some embodiments, the pressure relief assembly 1 also includes a cover plate 17, and the cover plate 17 is arranged at the first opening to close the first opening. When the embodiment shown in FIG. 6 is used, the cover plate 17 can be added to close the first opening, making the appearance more attractive.

In the above technical solution, the pressure relief device for the suction cup 3 includes the suction cup 3, the rod body 2, and the pressure relief assembly 1; the suction cup 3 is arranged at one end of the rod body 2, the rod body is provided with the first air relief groove 21, the rod body 2 is further provided with the first air hole 23 in the first air relief groove 21, and the first air hole 23 runs through the rod body 2 so that the air pipeline 22 is in communication with the outside; the pressure relief assembly 1 includes the first pressure relief member 11 and the first blocking end 12, the first blocking end 12 is placed in the air pipeline 22 from the first air relief groove 21, the first blocking end 12 is in transmission connection with the first pressure relief member 11, and the first blocking end 12 can block the first air hole 23 under the drive of the first pressure relief member 11 to close the air pipeline 22, so that the suction cup 3 remains in a vacuum suction state, or, the first blocking end 12 can also be separated from the first air hole 23 under the drive of the first pressure relief member 11, so that the air pipeline 22 is in communication with an external environment, thereby releasing the suction cup 3 from the vacuum state. When in use, a user only needs to apply force in the corresponding direction at the first pressure relief member 11. For a ski edge sharpening device, multiple suction cups 3 can be easily operated to improve the operating efficiency.

Finally, it should be noted that although the above embodiments have been described in the text of the specification and the drawings of the present invention, the patent protection scope of the present invention cannot be limited thereby. All technical solutions generated by replacing or modifying equivalent structures or equivalent processes based on the essential concept of the present invention and using the contents recorded in the specification and drawings of the present invention, as well as direct or indirect implementation of the technical solutions of the above embodiments in other related technical fields, are included in the patent protection scope of the present invention.

What is claimed is:

1. A pressure relief device for a suction cup, comprising:
the suction cup;
a rod body, wherein the rod body comprises an air pipeline, a first end, and a first air relief groove, the air pipeline runs through the rod body, the suction cup is arranged at the first end, the rod body is further provided with a first air hole in the first air relief groove, and the first air hole runs through the rod body so that the air pipeline is in communication with the outside; and
a pressure relief assembly, wherein the pressure relief assembly comprises a first pressure relief member and a first blocking end, the first blocking end is placed in the air pipeline from the first air relief groove, the first blocking end is in transmission connection with the first pressure relief member, the first blocking end can block the first air hole under the drive of the first pressure relief member to close the air pipeline, or, the first blocking end can be separated from the first air hole under the drive of the first pressure relief member to make the air pipeline in communication with the outside.

2. The pressure relief device for a suction cup according to claim 1, wherein
the first air relief groove is further provided with a first accommodating chamber, the first accommodating chamber is provided with a first opening facing the outside, the first air hole penetrates the first accommodating chamber, air enters the first accommodating chamber from the first air hole and then enters the air pipeline through the first accommodating chamber;
the first blocking end is placed in the first accommodating chamber from the first opening.

3. The pressure relief device for a suction cup according to claim 2, wherein the first pressure relief member comprises:
a first protruding portion placed in the first accommodating chamber and configured to move relative to the first accommodating chamber; and
a first gripping portion extending out of the first accommodating chamber and placed outside the rod body, wherein a force can be applied to the first gripping portion to drive the first protruding portion to move relative to the first accommodating chamber.

4. The pressure relief device for a suction cup according to claim 3, wherein
the first blocking end is an outer surface of the first protruding portion;
the pressure relief assembly further comprises a sealing ring, the sealing ring is arranged at a joint between the first accommodating chamber and the air pipeline, and the first blocking end is driven by the first pressure relief member to compress the sealing ring so that the first blocking end blocks the air pipeline.

5. The pressure relief device for a suction cup according to claim 3, wherein
the first blocking end is arranged on the first protruding portion;
the pressure relief assembly further comprises a first venting pipeline, the first venting pipeline and the first blocking end are arranged on the first protruding portion in a cross manner;
the first gripping portion is used to drive the first protruding portion to rotate by a first preset angle, so that two ends of the first venting pipeline are respectively in communication with the first air hole and the air pipeline;
the first gripping portion is also used to drive the first protruding portion to rotate by a second preset angle, so that the first blocking end respectively abuts against the first air hole and the air pipeline.

6. The pressure relief device for a suction cup according to claim 5, wherein
the first venting pipeline has a first connecting portion and a second connecting portion, and the first connecting portion and the second connecting portion are arranged at an angle;
when the first protruding portion rotates by the first preset angle, the first connecting portion is in communication with the first air hole, and the second connecting portion is in communication with the air pipeline.

7. The pressure relief device for a suction cup according to claim 3, wherein the pressure relief assembly further comprises:
a rotating plate, wherein the rotating plate comprises the first blocking end and a first transmission end, the rotating plate and the rod body are hinged in the first accommodating chamber, and the first transmission end is in transmission connection with the first protruding portion; and
an elastic member, wherein the elastic member is arranged between the first accommodating chamber and the first protruding portion, and the first protruding portion can move toward the outside of the rod body under the drive of the elastic member.

8. The pressure relief device for a suction cup according to claim 7, wherein
the first protruding portion is provided with a connecting groove, and the first transmission end is embedded in the connecting groove;
or, the first protruding portion is provided with a first convex column, the first transmission end is provided with a first through hole, and the first convex column passes through the first through hole, so that the first protruding portion is connected to the first transmission end.

9. The pressure relief device for a suction cup according to claim 7, wherein the first blocking end is coated with a rubber layer, a plastic layer, or a silicone layer.

10. The pressure relief device for a suction cup according to claim 2, wherein the pressure relief assembly further comprises a cover plate, and the cover plate is arranged at the first opening to close the first opening.
